(19) United States
(12) Patent Application Publication
(10) Pub. No.: US 2008/0090565 A1
(43) Pub. Date: Apr. 17, 2008

(54) Wireless communication modules for audio systems

(75) Inventor: Justin Chiwon Kim, Great Neck, NY (US)

Correspondence Address: GREENBERG TRAURIG, LLP, 200 PARK AVE., P.O. BOX 677, FLORHAM PARK, NJ, 07932, US

(73) Assignee: jWIN ELECTRONICS CORP.

(21) Appl. No.: 11/668,529

(22) Filed: Jan. 30, 2007

Related U.S. Application Data
(60) Provisional application No. 60/851,325, filed on Oct. 13, 2006.

(51) Int. Cl. H04Q 7/20

(52) U.S. Cl. 455/425

(57) ABSTRACT

A removable wireless communication module includes a connector configured to removably connect to an external port of a host device. The connector includes a power supply input connecting element to receive electrical power from the host device, at least one audio connecting element to receive audio signals from the host device and to transmit audio signals to the host device. The communication module is configured to transmit audio signals received from the host device to a remote device according to a predefined wireless communications protocol. The communication module is further configured to receive audio signals from a remote device and output the received audio signals to the host device.

### CROSS REFERENCE TO RELATED APPLICATIONS

This application claims the benefit of priority of U.S. Provisional Application Ser. No. 60/851,325 entitled “Wireless stereo network adapter module for audio device” filed on Oct. 13, 2006, the disclosure of which is hereby incorporated herein by reference.

### BACKGROUND OF THE INVENTION

1. Field of the Invention

The present invention generally relates wireless communication modules and audio devices and audio/video devices employing wireless communication modules.

2. Description of the Related Art

Entertainment systems, including audio devices and/or audio/video devices, are available in which two or more devices are configured to wirelessly communicate with each other. To establish wireless communication between two devices, the devices are required to employ wireless communications protocols that are at least compatible with each other. Consequently, if a user desires to integrate a wireless device employing a communications protocol that is not compatible with the communications protocol employed by other wireless devices in an entertainment system, such device may be prevented from being integrated into the entertainment system.

In addition to there being a number of different wireless communications protocols to select from, currently existing communication protocols may be developed further in the future, resulting in protocol standards being periodically changed. It is not economically desirable to replace an audio device or a video/audio device, each time communication protocol standards change, merely because there is a backward compatibility problem concerning wireless communications protocol employed by the device.

### SUMMARY OF EMBODIMENTS THE INVENTION

In accordance with a first aspect of the present invention, a wireless communication module is provided. The wireless communication module is configured to removably connect to a host device, such as, for example, an audio device and/or an audio/video device, so that the host device can wirelessly communicate with a remote device. The wireless communication module includes a transceiver, a controller coupled to the transceiver and an enclosure that contains the controller and transceiver. The wireless communication module further includes a connector coupled to the controller. The connector is configured to removably connect to an external port of the host device. In an embodiment, the connector includes a power supply input connecting element to receive electrical power from the host device, at least one audio connecting element to receive audio signals from the host device and to transmit audio signals to the host device.

In accordance with a second aspect of the present invention, a host device, such as, for example, an audio device or an audio/video device, configured for use with a removable wireless communication module is provided. The host device generally includes an audio source to process audio data and generate audio signals, an enclosure that contains the audio source, and an external port coupled to audio source. The external port of the host device is configured to removably connect to a wireless communication module. The external port includes a power supply output connecting element to supply electrical power to the communication module, at least one audio connecting element to transmit audio signals generated by the audio source to the communication module and to receive audio signals from the communication module.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 is a block diagram of a wireless entertainment system according to an embodiment of the present invention.

FIG. 2A is a simplified representation of connection lines coupled between a host audio device and a removable communication module according to a first embodiment of the present invention.

FIG. 2B is a simplified representation of connection lines coupled between a host audio device and a removable receiver module according to a second embodiment of the present invention.

FIG. 2C is a simplified representation of connection lines coupled between a host audio device and a removable transmitter module according to a third embodiment of the present invention.

FIG. 2D is a simplified representation of connection lines coupled between a host audio/video device and a removable communication module according to a fourth embodiment of the present invention.

FIG. 2E is a simplified representation of connection lines coupled between a host audio device and a removable communication module according to a fifth embodiment of the present invention.

FIG. 2F is a simplified representation of connection lines coupled between a host audio/video device and a removable communication module according to a sixth embodiment of the present invention.

FIG. 3 is a flowchart diagram illustrating a process executed by the host device according to an embodiment of the present invention.

FIG. 4 is a flowchart diagram illustrating a processor executed by the host device according to an embodiment of the present invention.

FIG. 5 is a block diagram of a wireless entertainment system according to an embodiment of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known components, structures and techniques have not been shown in detail in order to avoid obscuring embodiments of the present invention. It should be noted that, as used in the description herein and the claims, the meaning of “in” includes “in” and “on”.

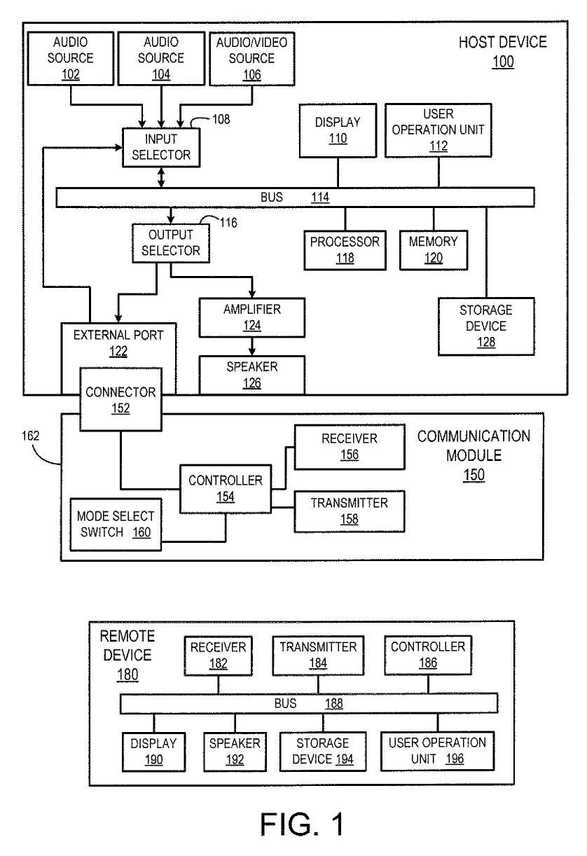

FIG. 1 shows a wireless entertainment system according to an embodiment of the present invention. The wireless system includes a host device 100 and a wireless communication module 150 removably connected to an external port 122 of the host device 100 for wirelessly communicating with a remote device 180. In an embodiment, the wireless communication module 150 is capable of transmitting high quality stereo sound signals from the host device 100 to the remote device 180. Additionally, in an embodiment, the wireless communication module 150 is further capable of receiving high quality stereo sound signals from the remote device 180 and forwarding the received sound signals to the host device 100.

In FIG. 1, a simplified representation of the wireless communication module 150 is shown. The communication module 150 comprises a number of functional elements including a receiver 156 operable to receive wireless signals, a transmitter 158 operable to transmit wireless signals, and a controller 154 coupled to the receiver and the transmitter. The communication module further includes an enclosure 162 that contains the receiver 156, the transmitter 158 and the controller 154. As shown in FIG. 1, a connector 152 is coupled to the controller 154 for removably connecting to the external port 122 of the host device. 100. In an embodiment, the connector 152 includes an external port disposed external to the enclosure 162 for removably connect the external port 122 of the host device 100.

Also included in the communication module 150 is a mode select switch 160 coupled to the controller 154. The mode select switch 160 is operable by a user to enable selection between a transmitter mode and a receiver mode. In operation, when the communication module 150 is in the transmitter mode, the controller 154 is configured to receive signals (e.g., audio signals and/or video signals) from the host device 100 via the external port 122 and transmit wireless signals to the remote device 180 according to a predefined wireless communications protocol (e.g., Bluetooth protocol, wireless LAN protocol, Ethernet protocol). On the other hand, when the communication module 150 is in the receiver mode, the controller 154 is configured to receive wireless signals (e.g., audio signals and/or video signals) from the remote device 180 according to the predefined wireless communications protocol (e.g., Bluetooth protocol, wireless LAN protocol, Ethernet protocol) and output the received signals (e.g., audio signals and/or video signals) to the host device 100 via the connector 152. In an embodiment, the communication module 150 is capable of communicating the currently selected operation mode (e.g., transmitter mode and/or the receiver mode selected by the user) to the host device 100 via a connection line between the connector 152 and the external port 122.

In FIG. 1, a simplified representation of the host device 100 is shown. The host device 100 comprises a number of functional elements including a processor 118 coupled to a memory 120, a speaker 126 coupled to an amplifier 124, a user operation unit 112, a storage device 128 and a display device 110 coupled to each other via a bus 114. The user operation unit 112 may include various user input control devices such as switches, knobs arranged on an external panel. In an embodiment, the host device 100 is an audio device including one or more audio source 102, 104 such as, for example, CD player, MP3 player, MD player, tape player, tuner and/or other suitable types of audio sources or any combination thereof. In another embodiment, the device is an audio/video device including one or more audio/video source 106, such as, for example, DVD player, personal computer, audio/video web services and/or other suitable types of audio/video sources or any combination thereof. It is noted that the audio sources 102, 104 and audio/video sources 106 may be contained internally within the host device 100 or may be separate external devices connectable to host device 100.

Also included in the host device 100 is an output selector 116 coupled to the amplifier 124 and the external port 122. The output selector 116 is configured to receive signals (e.g., audio signals and/or video signals) from an input selector 108 and output the received signals to either the amplifier 124 or the communication module 150 via the external port 122 based on an instruction received from the processor 118. In an embodiment, when the communication module 150 is in the transmitter mode, the output selector 116 outputs the signals received from the input selector 108 to the communication module 150 via the external port 122.

The input selector 108 receives input signals (e.g., audio signals and/or video signals) from various input sources and outputs received signals from a selected source to the output selector 116. More specifically, in the illustrated embodiment, the input selector 108 is coupled to receive input signals (e.g., audio signals and/or video signals) from audio sources 102, 104 and the audio/video source 106. Also coupled to the input selector 108 is the communication module 150 via the external port 122 such that signals (e.g., audio signals and/or video signals) transmitted from the communication module 150 to the host device 100 is input to the input selector 108. Input signals (e.g., audio signals and/or video signals) generated by one of the sources 102, 104, 106 or input signals received from the communication module 150 is selected by the input selector 108. The input selector 108 is controlled by the processor 118 based on user input received via the user operation unit 112 and/or a current operating mode of the communication module 150. In an embodiment, when the communication module 150 is in the receiver mode to receive audio signals from the remote device 180, the processor 118 instructs the input selector 108 to select the communication module 150 via the external port 122 as the input source such that signals received from the communication module 150 are transmitted to the output selector 116.

The signals generated by the input source selected by the input selector 108 are transmitted to the output selector 116. Then, the output selector 116 outputs the input signals received from the input selector 108 to either the speaker 126 (via the amplifier 124) or the communication module 150 via the external port 122. Alternatively, the output selector 116 may be instructed by the processor 118 to output the input signals received from the input selector to both the speaker 126 and the communication module 150. The output selector 116 is controlled by the processor 118 based on user input received via the user operation unit 112 and/or a current operating mode of the communication module 150. In an embodiment, when the communication module 150 is in the transmitter mode to transmit wireless signals to the remote device 180, the processor 118 instructs the output selector 116 to output signals (e.g., audio signals and/or video signals) received from the input selector 108 to the communication module 150 via the external port 122 so that the communication module 150 can be employed to transmit wireless signals to the remote device 180 according to specific wireless communications protocol.

In FIG. 1, a simplified representation of a remote device 180 is shown. The remote device 180 comprises a number of functional elements including a receiver 182 operable to receive wireless signals, a transmitter 184 operable to transmit wireless signals, and a controller 186 coupled to the receiver and the transmitter. The illustrated remote device 180 further includes a display 190, a speaker 192, a storage device 194 and a user operation unit 196 coupled via a bus 188.

According to one implementation, the wireless entertainment system illustrated in FIG. 1 enables a user to listen to songs stored on the remote device 180 through the speaker 126 of the host device 100 as if the remote device 180 is directly attached to the host device through an auxiliary input port. This can be accomplished by operating the communication module 150 in the receiver mode such that audio signals generated by the remote device 180 can be wireless received by the host device 100 via the communication module 150. In a case where the remote device 180 is a headset, a user of the headset (remote device 180) can listen to songs stored on the host device 100 as if the headset is directly plugged in an input jack of the host device 100. This can be accomplished by operating the communication module 150 in the transmitter mode such that audio signals generated by the host device 100 can be wireless transmitted to the headset (remote device 180) via the communication module 150.

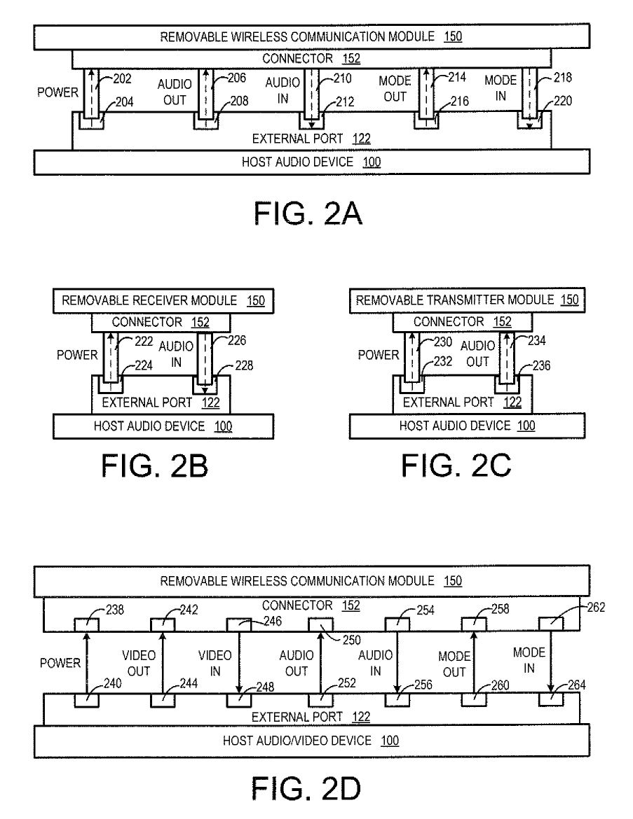

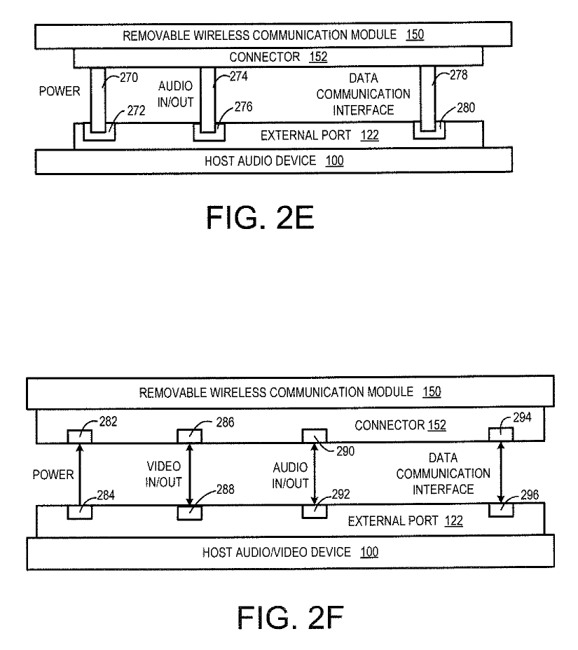

The wireless communication module 150 and the host device 100 communicate with each other through a defined number of electrical connection lines. FIG. 2A shows connection lines coupled between a host device and a removable wireless communication module according to a first embodiment of the present invention.

In the embodiment illustrated in FIG. 2A, the communication module 150 is configured to support both a receiver mode of operation in which the communication module is used to receive audio signals from a remote device and a transmitter mode of operation in which the communication module is used to transmit audio signals received from the host device to a remote device. In this regard, the communication module 150 comprises a connector 152 (e.g., an external port) that includes power supply input connecting element 202, audio input connecting element 206, audio output connecting element 210, mode selection input connection element 214 and mode selection output connection element 218. The power supply input connecting element 202 is used to receive electrical power from the host device 100. The audio input connecting element 206 is used to receive audio signals from the host device 100. Although one audio input connecting element 206 is illustrated in FIG. 2A, it should be noted that more than one audio input connecting element (e.g., audio left input, audio right input) may be utilized. The audio output connecting element 210 is used to transmit audio signals to the host device. Although one audio output connecting element 210 is illustrated in FIG. 2A, it should be noted that more than one audio output connecting element (e.g., audio left output, audio right output) may be utilized. The mode selection input connection element 214 is used to receive a signal from the host device indicating an operation mode (e.g., transmitter mode, receiver mode) selected by the host device. The mode selection output connection element 218 is used to transmit a signal from the communication module to the host device indicating whether the communication module is in the transmitter mode or the receiver mode.

In the embodiment illustrated in FIG. 2A, the host device 100 includes an external port 122 including power supply output connecting element 204, audio output connecting element 208, audio input connecting element 212, mode selection output connection element 216 and mode selection input connection element 220. The power supply output connecting element 204 is used to supply electrical power from the host device 100 to the communication module 150. The audio output connecting element 208 is used to transmit audio signals from the host device 100 to the communication module 150. Although one audio output connecting element 208 is illustrated in FIG. 2A, it should be noted that more than one audio output connecting element (e.g., for audio left output, audio right output) may be utilized. The audio input connecting element 212 is used to receive audio signals from the communication module 150. Although one audio input connecting element 212 is illustrated in FIG. 2A, it should be noted that more than one audio input connecting element (e.g., for audio left input, audio right input) may be utilized. The mode selection output connection element 216 is used to transmit a signal from the host device 100 to the communication module 150 indicating an operation mode (e.g., transmitter mode, receiver mode) selected by the host device 100. The mode selection input connection element 220 is used to receive a signal from the communication module 150 indicating whether the communication module is in the transmitter mode of operation or the receiver mode of operation.

FIG. 2B shows connection lines coupled between a host audio device and a removable receiver module according to a second embodiment of the present invention. In the embodiment illustrated in FIG. 2B, the communication module 150 is configured to support only the receiver mode of operation to receive wireless signals from a remote device. In this regard, the host device 100 comprises an external port 122 that includes two connection elements, namely, power supply output connecting element 224 to supply electrical power to the communication module and audio input connecting element 228 to receive audio signals from the communication module 150. As shown in FIG. 2B, the removable wireless communication module 150 comprises a connector 152 (e.g., an external port) that includes two corresponding connection elements, namely, power supply input connecting element 222 to receive electrical power from the host device 100 and audio output connecting element 226 used to transmit audio signals to the host device 100.

FIG. 2C shows connection lines coupled between a host audio device and a removable transmitter module according to a third embodiment of the present invention. In the embodiment illustrated in FIG. 2C, the communication module 150 is configured to support only the transmitter mode of operation to transmit wireless signals to a remote device. In this regard, the host device 100 comprises an external port that includes two connection elements, namely, power supply output connecting element 232 to supply electrical power to the communication module 150 and audio output connecting element 236 to transmit audio signals from the host device 100 to the communication module 150. As shown in FIG. 2C, the removable wireless communication module 150 comprises a connector 152 (e.g., an external port) that includes two corresponding connection elements, namely, power supply input connecting element 230 to receive electrical power from the host device 100 and audio input connecting element 234 used to receive audio signals from the host device 100.

FIG. 2D shows connection lines coupled between a host audio/video device and a removable communication module according to a fourth embodiment of the present invention. In the fourth embodiment, video signal lines are added to the first embodiment shown and described with reference to FIG. 2A. More specifically, in the embodiment illustrated in FIG. 2D, the host device 100 includes an external port 122 having video output connecting element 244 and video input connecting element 248 in addition to power supply output connecting element 240, audio output connecting element 252, audio input connecting element 256, mode selection output connection element 260 and mode selection input connection element 264. The video output connecting element 244 is used to transmit video signals from the host device 100 to the communication module 150. The video input connecting element 248 is used to receive video signals from the communication module 150.

In the embodiment illustrated in FIG. 2D, the removable wireless communication module 150 comprises a connector 152 (e.g., an external port) having video input connecting element 242 and video output connecting element 246 in addition to power supply input connecting element 238, audio input connecting element 250, audio output connecting element 254, mode selection input connection element 258 and mode selection output connection element 262. The video input connecting element 242 is used to receive video signals from the host device 100. The video output connecting element 246 is used to transmit video signals from the communication module 150 to the host device 100.

FIG. 2E shows connection lines coupled between a host audio device and a removable communication module according to a fifth embodiment of the present invention. In the embodiment illustrated in FIG. 2E, the two separate pins for audio input and audio output (as shown in FIG. 2A) are replaced with a single audio input/output connection line. Additionally, the two separate pins for mode in and mode out (as shown in FIG. 2A) are replaced with a data communication interface. The data communication interface may comprise a single connection line or alternatively, may comprise a plurality of connection lines.

In an embodiment, the data communication interface uses universal asynchronous receiver/transmitter (UART) to exchange data between the host device and the communication module. It is noted that the data communication interface illustrated in FIG. 2E may utilize any other suitable communication protocol, including universal serial bus (USB), inter-integrated circuit (I2C), and the like to receive and send data signals between the host device and the communication module.

In this regard, the host device 100 comprises an external port 122 that includes at least three connection elements, namely, power supply output connecting element 272, audio input/output connecting element 276, and at least one data communication interface connecting element 280. The power supply output connecting element 272 is used to supply electrical power from the host device 100 to the communication module 150. The audio input/output connecting element 276 is used to receive/transmit audio signals between the host device 100 and the communication module 150. The data communication interface connecting element 280 is used to transmit/receive data signals between the host device 100 and the communication module 150. The data signals exchanged between the host device 100 and the communication module include, but not limited to, a signal indicating an operation mode (e.g., transmitter mode, receiver mode) and signals relating to remote control functions. In an embodiment, the operation mode is only selectable via the communication module. In another embodiment, the operation mode is selectable either via the communication module and/or the host device.

In the embodiment illustrated in FIG. 2E, the communication module 150 comprises a connector 152 (e.g., an external port) that includes power supply input connecting element 270, audio input/output connecting element 274 and at least one data communication interface connecting element 278. The power supply input connecting element 270 is used to receive electrical power from the host device 100. The audio input/output connecting element 274 is used to transmit/receive audio signals to/from the host device 100. The data communication interface connecting element 278 is used to exchange data signals between the host device 100 and the communication module 150.

In an embodiment, the communication module 150 is used to wirelessly receive data signals for remotely controlling various functions of the host device 100 (e.g., remote control data signals) from the remote device 180 and to forward the received data signals (e.g., remote control data signals) to the host device 100 via the data communication interface connecting element 278.

FIG. 2F shows connection lines coupled between a host audio/video device and a removable communication module according to a sixth embodiment of the present invention. In the embodiment illustrated in FIG. 2F, the two separate pins for audio input and audio output (as shown in FIG. 2D) are replaced with a single audio input/output connection line. Moreover, the two separate pins for video input and video output (as shown in FIG. 2D) are replaced with a single audio input/output connection line. Furthermore, the two separate pins for mode in and mode out (as shown in FIG. 2D) are replaced with a data communication interface. The data communication interface may comprise a single connection line or alternatively, may comprise a plurality of connection lines. In an embodiment, the data communication interface uses universal asynchronous receiver/transmitter (UART) to exchange data between the host device and the communication module.

In this regard, the host device 100 comprises an external port 122 that includes at least four connection elements, namely, power supply output connecting element 284, video input/output connecting element 288, audio input/output connecting element 292, and at least one data communication interface connecting element 296. The data communication interface connecting element 296 is used to transmit/receive data signals between the host device 100 and the communication module 150. The data signals exchanged between the host device 100 and the communication module include, but not limited to, a signal indicating an operation mode (e.g., transmitter mode, receiver mode) and signals relating to remote control functions. In an embodiment, the operation mode is only selectable via the communication module. In another embodiment, the operation mode is selectable either via the communication module and/or the host device.

In the embodiment illustrated in FIG. 2F, the communication module 150 comprises a connector 152 (e.g., an external port) that includes power supply input connecting element 282, video input/output connecting element 286, audio input/output connecting element 290 and at least one data communication interface connecting element 294. In an embodiment, the communication module 150 is used to wirelessly receive data signals for remotely controlling various functions of the host device 100 (e.g., remote control data signals) from the remote device 180 and to forward the received data signals (e.g., remote control data signals) to the host device 100 via the data communication interface connecting element 294.

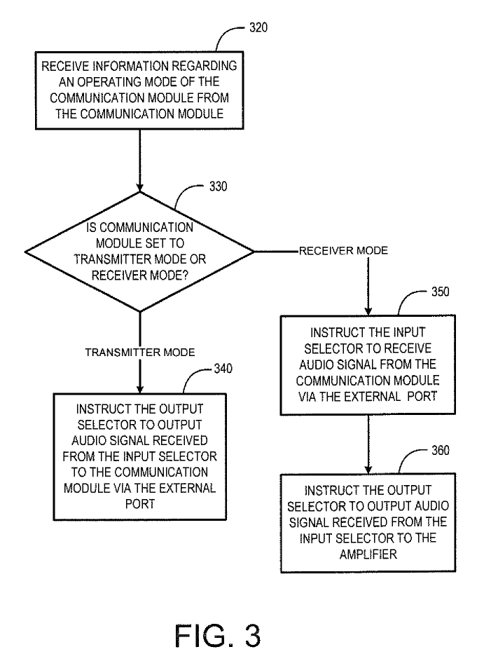

FIG. 3 is a flowchart diagram illustrating a process executed by the host device according to an embodiment of the present invention. As noted above, in an embodiment, the communication module 150 has a mode select switch 160 that can be operated by a user to selectively set the communication module to either a transmitter mode in which the communication module is used to transmit audio signals received from the host device to a remote device or a receiver mode in which the communication module is used to receive audio signals from a remote device. Accordingly, in block 320, the processor 118 of the host device 100 (also referred to herein as “host processor”) receives a signal from the communication module 150 via the mode selection input connection element 220 of the external port 122 indicating whether the communication module is set to the transmitter mode or the receiver mode. Then in block 330, the host processor 118 determines, based on the signal received from the communication module 150, whether the communication module is set to the transmitter mode or the receiver mode. If it is determined that the communication module 150 is in the transmitter mode, the process proceeds to block 340 in which the host processor 118 instructs the output selector 116 to output audio signals received from the input selector 108 to the communication module 150 via the external port 122. On the other hand, if it is determined that the communication module 150 is in the receiver mode, the process proceeds to block 350 in which the host processor 118 instructs the input selector 108 to select audio signals received from the communication module 150 via the external port 122 for inputting into the output selector 116. Next in block 360, the host processor 118 instructs the output selector 116 to output audio signals received from the input selector 108 to the amplifier 124.

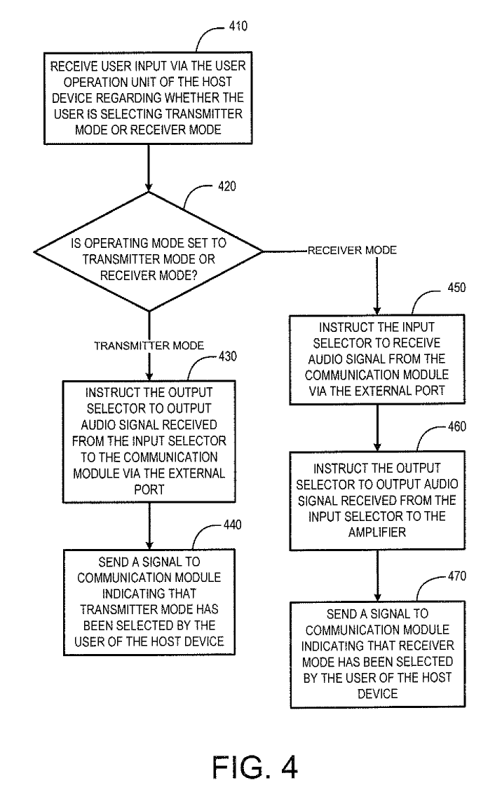

FIG. 4 is a flowchart diagram illustrating a process executed by the host device according to an embodiment of the present invention. In an embodiment, the host device 100 is configured to enable a user to select, using the user operating unit 112 of the host device 100, between a transmitting mode in which the communication module 150 is used to transmit audio signals received from the host device to the remote device 180 and a receiver mode in which the communication module 150 is used to receive audio signals from the remote device 150. Accordingly, in block 410, the user operating unit 112 of the host device 100 receives a user input regarding whether the user wishes to select the transmitting mode or the receiver mode. Then, in block 420, the host processor 118 determines if the user has selected the transmitter mode or the receiver mode. If it is determined that the user has selected the transmitter mode, the process proceeds to block 430 in which the host processor 118 instructs the output selector 116 to output audio signals received from the input selector 108 to the communication module 150 via the external port 122. Next in block 440, the host processor 118 sends a signal via the mode selection output connection element 216 (shown in FIG. 2A) of the external port 122 to the communication module 150 indicating that the transmitter mode has been selected by the user of the host device 100. On the other hand, if it is determined that the user has selected the receiver mode, the process proceeds to block 450 in which the host processor 118 instructs the input selector 108 to select audio signals received from the communication module 150 via the external port 122 for inputting into the output selector 116. Then in block 460, the host processor 118 instructs the output selector 116 to output audio signals received from the input selector 108 to the amplifier 124. Next in block 470, the host processor 118 sends a signal via the mode selection output connection element 216 (shown in FIG. 2A) of the external port 122 to the communication module 150 indicating that the receiver mode has been selected by the user of the host device 100.

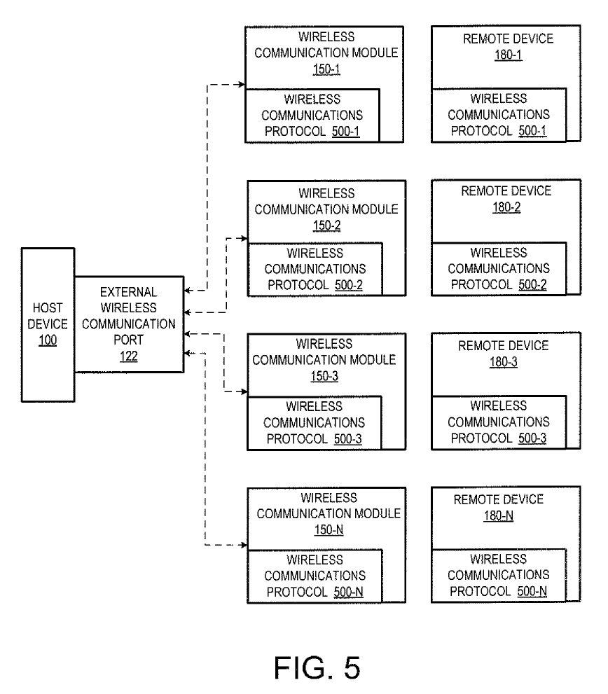

FIG. 5 is a block diagram of a wireless entertainment system according to an embodiment of the present invention. In the system illustrated in FIG. 5, a host device 100 may communicate with a first remote device 180-1 employing a first wireless communications protocol 500-1 via a first wireless communication module 150-1 employing the first wireless communications protocol 500-1. When a user desires to use the host device 100 to communicate with a second remote device 180-2 using a second wireless communications protocol 500-2. The first communication module 150-1 can be removed from the external wireless communication port 122 of the host device 100 and replaced with the second communication module 150-2 that is suitable for communicating with the second remote device 180-2 using the second wireless communications protocol 150-2. By doing so, when the user wishes to integrate or replace a remote device with another wireless target device that is configured to communicate using a different wireless communication protocols into the entertainment system, such replacement device can be easily integrated into the entertainment system by selecting an appropriate wireless communication module that uses the same wireless communications protocol as the replacement device and connecting the wireless communication module to the host device.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

1. A communication module comprising:
a transmitter operable to transmit wireless signals;
a receiver operable to receive wireless signals;
a controller coupled to the transmitter and the receiver;
an enclosure that contains the controller, the transmitter and the receiver; and
an connector coupled to the controller, the connector configured to removably connect to a port of a host device, the connector including a power supply input connecting element to receive electrical power from the host device, and at least one audio connecting element to receive audio signals from the host device and to transmit audio signals to the host device.

2. The communication module of claim 1, wherein the connector further includes at least one data communication interface connection element to receive data signals from the host device and to transmit data signals to the host device.

3. The communication module of claim 2, wherein the controller is configured to receive remote control data signals for remotely controlling functions of the host device from a first remote device and to forward the received remote control data signals to the host device via the data communication interface connecting element, the controller being configured to receive remote control data signals for remotely controlling functions of the a second remote device from the host device and to forward the received remote control data signals to a the second remote device via the data communication interface connection element.

4. The communication module of claim 1,
wherein the port of the host device comprises an external port, and
wherein the connector includes an external port disposed external to the enclosure that is configured to removably connect to the external port of the host device.

5. The communication module of claim 1, wherein the controller is configured to receive audio signals from the host device via the audio connecting element of the connector and transmit wireless audio signals via the transmitter to a remote device according to a predefined wireless communications protocol; and wherein the controller is configured to receive audio signals wirelessly from a remote device via the receiver according to the predefined wireless communications protocol and output the received audio signals to the host device via the audio connecting element of the connector.

6. (canceled)

7. (canceled)

8. The communication module of claim 2, wherein the controller is selectable between a transmitter mode in which the transmitter is used to transmit audio signals received from the host device to a remote device and a receiver mode in which the receiver is used to receive audio signals from a remote device.

9. The communication module of claim 8, further comprising:
a user operable switch coupled to the controller to enable selection between the transmitter mode and the receiver mode, wherein the data communication interface connecting element is used to transmit a signal from the communication module to the host device indicating one of the transmitter mode and the receiver mode selected using the user operable switch.

10. (canceled)

11. The communication module of claim 1, wherein the connector further comprises:
at least one video connecting element to receive video signals from the host device and to transmit video signals to the host device.

12. An apparatus comprising:
an audio source to process audio data and generate audio signals;
an enclosure that contains the audio source; and
an external port coupled to the audio source, the external port configured to removably connect to a wireless communication module) the external port including a power supply output connecting element to supply electrical power to the communication module) at least one audio connecting element to transmit audio signals generated by the audio source to the communication module and to receive audio signals from the communication module.

13. The apparatus of claim 12, wherein the external port further includes at least one data communication interface connecting element to transmit data signals to the communication module and to receive data signals from the communication module, the data communication interface connecting element being used to receive remote control data signals from the communication module.

14. (canceled)

15. The apparatus of claim 12, further comprising:
an output selector coupled between the audio source and the external port; and
a speaker coupled to the output selector,
wherein the output selector selects one of the speaker and the external port for receiving audio output signals based on an operation mode of the wireless communication module, and wherein the output selector prevents the audio output signals from being received by the speaker and forwards the audio output signals to the communication module via the external port if the communication module is in a transmitting mode.

16. (canceled)

17. The apparatus of claim 12, further comprising:
an output selector;
a speaker coupled to the output selector; and
an input selector coupled to receive audio signals from the audio source and the external port, wherein audio signals received from one of the audio source and the external port is selected by the input selector for inputting into the output selector, wherein the input selector selects audio signals received from the external port for inputting into the output selector if the communication module is in a receiver mode in which the communication module is used to receive audio signals from a remote device.

18. (canceled)

19. The apparatus of claim 12, further comprising:
a user operation unit to enable selection between a transmitting mode in which the communication module is used to transmit audio signals received from the external port to a remote device and a receiver mode in which the communication module is used to receive audio signals from a remote device.

20. The apparatus of claim 12, wherein the external port includes a mode selection connecting element to receive a signal from the communication module indicating whether the communication module is in a transmitter mode in which the communication module is used to transmit audio signals received from the audio source to a remote device or a receiver mode in which the communication module is used to receive audio signals from a remote device.

21. The apparatus of claim 12, wherein the external port is configured to connect the communication module such that the communication module is disposed external to the enclosure of the apparatus.

22. The apparatus of claim 12, further comprising:
a video source to process video data and generate video signals,
wherein the external port further includes:
at least one video connecting element to transmit video signals generated by the video source to the communication module and to receive video signals from the communication module.

23. A system comprising:
a host device capable of processing audio data to generate audio signals, the host device having an external port; and
a communication module having a connector configured to removably couple to the external port of the host device, the connector of the communication module including a power supply input connecting element to receive electrical power from the host device, at least one audio connecting element to receive audio signals from the host device and to transmit audio signals to the host device.

24. The system of claim 23, wherein the communication module further comprises:
a transmitter operable to transmit wireless signals;
a receiver operable to receive wireless signals;
a controller coupled to the transmitter and the receiver, the controller configured to receive audio signals from the host device via the audio connecting element of the connector and transmit wireless audio signals via the transmitter to a remote device according to a predefined wireless communications protocol, the controller being configured to receive audio signals wirelessly from a remote device via the receiver according to the predefined wireless communications protocol and output the received audio signals to the host device via the audio output connecting element of the connector.

25. The system of claim 24, wherein the communication module further comprises:
an enclosure that contains the controller, the transmitter and the receiver, wherein the connector includes an external port disposed external to the enclosure that is configured to removably connect to the external port of the host device.

26. The system of claim 24, wherein the communication module includes a mode select switch that is operable by a user to select between a transmitter mode in which the communication module is used to transmit audio signals received from the host device to a remote device and a receiver mode in which the communication module is used to receive audio signals from a remote device.

27. The system of claim 26, wherein the connector of the communication module further includes a mode selection output connecting element to transmit-a signal to the host device indicating one of the transmitter mode or the receiver mode selected using the mode select switch.

28. The system of claim 24, wherein the host device further comprises:
an audio source to process audio data and generate audio signals;
an output selector coupled between the audio source and the external port; and
a speaker coupled to the output selector,
wherein the output selector selects one of the speaker and the external port for receiving audio signals based on an operation mode of the communication module.

29. The system of claim 28, wherein the host device further comprises:
an input selector coupled to receive audio signals from the audio source and the external port of the host device, wherein audio signals received from one of the audio source and the external port of the host device is selected by the input selector for inputting into the output selector, wherein the input selector selects audio signals received from the external port of the host device for inputting into the output selector if the communication module is in a receiver mode in which the communication module is used to receive audio signals from a remote device.

30. (canceled)

31. (canceled)

32. The system of claim 23, further comprising:
a remote device that is capable of wirelessly communicating with the communication module coupled to the host device.

33. The system of claim 32, wherein the remote device includes at least one of a speaker and a headset to output audio based on signals received from the communication module connected to the host device.

34. (canceled)
